(19) United States
(12) Patent Application Publication
(10) Pub. No.: US 2024/0045125 A1
(43) Pub. Date: Feb. 8, 2024

(54) OPTICAL ANGULAR FILTER

(71) Applicant: ISORG, Limoges CEDEX 3 (FR)

(72) Inventors: Benjamin BOUTHINON, GRENOBLE (FR); Delphine DESCLOUX, GRENOBLE (FR); Wilfrid SCHWARTZ, GRENOBLE (FR)

(21) Appl. No.: 18/266,547

(22) PCT Filed: Nov. 22, 2021
(86) PCT No.: PCT/EP2021/082404

§ 371 Date: Jun. 9, 2023

(30) Foreign Application Priority Data
Dec. 14, 2020 (FR) 20/13151

(51) Int. Cl. G02B 5/28; G02B 5/20; G02B 3/00

(52) U.S. Cl. CPC G02B 5/286; G02B 5/201; G02B 5/281; G02B 5/208; G02B 3/0006

(57) ABSTRACT

An angular filter for an image acquisition device including a stack includes: a layer with mediums having different refraction indexes and transparent to the radiation, the layer only letting through rays of the radiation having incidences smaller than a first maximum incidence; and an array of openings delimited by walls opaque to a visible and/or infrared radiation and an array of microlenses. The assembly formed by the array of openings and the array of microlenses only lets through rays having incidences smaller than a second maximum incidence smaller than the first maximum incidence.

### RELATED APPLICATION

The present application is based on and claims priority of French patent application FR2013151 filed on Dec. 14, 2020 and entitled “Filtre angulaire optique”, which is incorporated herein by reference as authorized by law.

### FIELD

The present disclosure concerns an optical angular filter.

More particularly, the present disclosure concerns an angular filter intended to be used within an optical system, for example, an imaging system, or to be used to collimate the rays of a light source, particularly for an application of directional illumination by an organic light-emitting diode (OLED), liquid crystal display (LCD), or by a light-emitting diode, possibly coupled to a waveguide or an application of optical inspection, for example, of fingerprint or vein capture.

### BACKGROUND

An angular filter is a device enabling to filter an incident radiation according to the incidence of this radiation and thus to block rays having an incidence greater than a maximum incidence. Angular filters are frequently used in association with image sensors.

### SUMMARY OF THE INVENTION

There is a need to improve known angular filters.

An embodiment overcomes all or part of the disadvantages of known angular filters.

An embodiment provides an angular filter for an image acquisition device comprising a stack comprising:
a layer comprising mediums having different refraction indexes and transparent to said radiation, the layer only letting through the rays of said radiation having incidences smaller than a first maximum incidence; and an array of openings delimited by walls opaque to a visible and/or infrared radiation and an array of microlenses.
the assembly formed by the array of openings and the array of microlenses only letting through the rays of said radiation having incidences smaller than a second maximum incidence smaller than the first maximum incidence.

According to an embodiment, said layer comprises a plurality of sub-layers.

According to an embodiment, the refraction index of each sub-layer is different from the refraction index of the sub-layer that it covers by at least 0.15, preferably 0.2.

According to an embodiment, the layer is an interference filter.

According to an embodiment, the layer is a fiber optic panel.

According to an embodiment, the layer comprises a group of optical fibers.

According to an embodiment, the layer comprises a group of parallel optical fibers, each surrounded with an opaque material.

According to an embodiment, the layer corresponds to a microstructured layer that can be assimilated to a photonic crystal, the microstructured layer having a resolution greater than the resolution of the array of microlenses.

According to an embodiment, the layer comprises a film of a first material transparent to said radiation crossed by pillars of a second material transparent to said radiation arranged in an array.

According to an embodiment, the array of microlenses is located between the array and the layer.

According to an embodiment, the layer is located between the array of microlenses and the array.

According to an embodiment, the array is located between the array of microlenses and the layer.

According to an embodiment, the first maximum incidence which corresponds to the half width at half maximum of the transmittance is smaller than 10°, preferably smaller than 4°.

According to an embodiment, the first maximum incidence which corresponds to the half width at half maximum of the transmittance is greater than 15° and smaller than 60°.

According to an embodiment, the first maximum incidence is smaller than or equal to 30°.

According to an embodiment, the openings are filled with air, with a partial vacuum, or with a material at least partially transparent in the visible and infrared ranges.

According to an embodiment:
each opening is topped with a single microlens;
each microlens covers a single opening; and/or
the optical axis of each microlens is aligned with the center of an opening.

An embodiment provides an image acquisition device comprising an angular filter such as described hereabove and an image sensor.

### BRIEF DESCRIPTION OF THE DRAWINGS

The foregoing features and advantages, as well as others, will be described in detail in the rest of the disclosure of specific embodiments given by way of illustration and not limitation with reference to the accompanying drawings, in which:

FIG. 1 illustrates an embodiment of an image acquisition system;

FIG. 2 illustrates, in a partial and simplified cross-section view, an embodiment of an image acquisition device comprising an angular filter;

FIG. 3 shows, in a graph, the transmittance of the angular filter of the device illustrated in FIG. 2 according to the incidence of the rays reaching the angular filter;

FIG. 4 illustrates, in a partial and simplified cross-section view, another embodiment of an image acquisition device comprising an angular filter;

FIG. 5 illustrates another embodiment of an image acquisition device comprising an angular filter; and

FIG. 6 illustrates, in a partial and simplified cross-section view, another embodiment of an image acquisition device comprising an angular filter.

### DESCRIPTION OF THE EMBODIMENTS

Like features have been designated by like references in the various figures. In particular, the structural and/or functional features that are common among the various embodiments may have the same references and may dispose identical structural, dimensional and material properties.

For the sake of clarity, only the steps and elements that are useful for an understanding of the embodiments described herein have been illustrated and described in detail. In particular, the forming of the image sensor and of the elements other than the angular filter has not been detailed, the described embodiments and implementation modes being compatible with usual embodiments of the sensor and of these other elements.

In the following disclosure, when reference is made to absolute positional qualifiers, such as the terms “front”, “back”, “top”, “bottom”, “left”, “right”, etc., or to relative positional qualifiers, such as the terms “above”, “below”, “upper”, “lower”, etc., or to qualifiers of orientation, such as “horizontal”, “vertical”, etc., reference is made, unless specified otherwise, to the orientation of the figures.

Unless specified otherwise, the expressions “around”, “approximately”, “substantially” and “in the order of” signify within 10%, and preferably within 5%.

Unless specified otherwise, the expressions “all the elements”, “each element”, signify between 95% and 100% of the elements.

Unless specified otherwise, the expression “it only comprises the elements” signifies that it comprises, by at least 90%, the elements, preferably that it comprises, by at least 95%, the elements.

For the needs of the present disclosure, the refraction index of a medium is defined as being the refraction index of the material forming the medium for the wavelength range of the radiation captured by the image sensor. The refraction index is considered as substantially constant over the wavelength range of the useful radiation, for example, equal to the average of the refraction index over the wavelength range of the radiation captured by the image sensor.

In the following description, unless specified otherwise, a layer or a film is called opaque to a radiation when the transmittance of the radiation through the layer or the film is smaller than 10%. In the following description, a layer or a film is called transparent to a radiation when the transmittance of the radiation through the layer or the film is greater than 10%. According to an embodiment, for a same optical system, all the elements of the optical system which are opaque to a radiation have a transmittance which is smaller than half, preferably smaller than one fifth, more preferably smaller than one tenth, of the lowest transmittance of the elements of the optical system transparent to said radiation. In the rest of the disclosure, there is called “useful radiation” the electromagnetic radiation crossing the optical system in operation. In the following description, there is called “micrometer-range optical element” an optical element formed on a surface of a support having a maximum dimension, measured parallel to said surface, greater than 1 μm and smaller than 1 mm.

Embodiments of optical systems will now be described for optical systems comprising an array of micrometer-range optical elements in the case where each micrometer-range optical element corresponds to a micrometer-range lens, or microlens, formed of two diopters. It should however be clear that these embodiments may also be implemented with other types of micrometer-range optical elements, where each micrometer-range optical element may for example correspond to a micrometer-range Fresnel lens, to a micrometer-range index gradient lens, or to a micrometer-range diffraction grating.

In the rest of the description, there is called visible light an electromagnetic radiation having a wavelength in the range from 400 nm to 700 nm, and, in this range, red light an electromagnetic radiation having a wavelength in the range from 600 nm to 700 nm. There is called infrared radiation an electromagnetic radiation having a wavelength in the range from 700 nm to 1 mm. In infrared radiation, one can particularly distinguish near infrared radiation having a wavelength in the range from 700 nm to 1.7 μm.

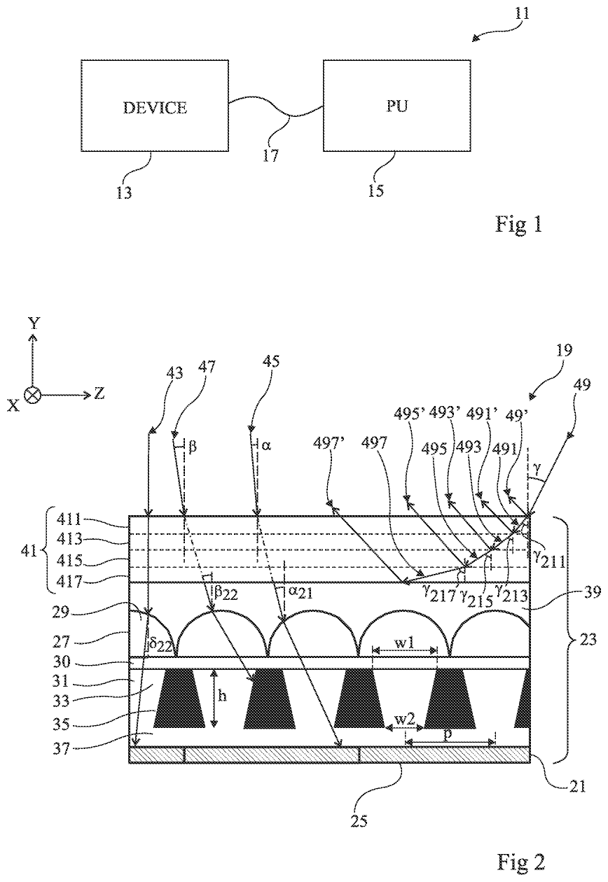

FIG. 1 illustrates an embodiment of an image acquisition system 11.

Image acquisition system 11, illustrated in FIG. 1, comprises:
an image acquisition device 13 (DEVICE); and
a processing unit 15 (PU).

Processing unit 15 preferably comprises means for processing the signals delivered by device 11, not shown in FIG. 1. Processing unit 15 for example comprises a microprocessor.

Device 13 and processing unit 15 are preferably coupled by a link 17. Device 13 and processing unit 15 are for example integrated in a same circuit.

FIG. 2 illustrates, in a partial and simplified cross-section view, an embodiment of an image acquisition device 19 comprising an angular filter.

The image acquisition device 19 shown in FIG. 2 comprises, from bottom to top in the orientation of the drawing:
an image sensor 21; and
an angular filter 23, covering image sensor 21.

In the present disclosure, the embodiments of the devices of FIGS. 2 to 4 are shown in space according to a direct orthogonal coordinate system XYZ, the Y axis of system XYZ being orthogonal to the upper surface of image sensor 21.

Image sensor 21 comprises an array of photon sensors 25, also called photodetectors. Photodetectors 25 are preferably arranged in array form. Photodetectors 25 may be covered with a protective coating, not shown. Photodetectors 25 preferably all have the same structure and the same properties/characteristics. In other words, all photodetectors 25 are substantially identical, to within manufacturing differences. Image sensor 21 further comprises conductive tracks and switching elements, particularly transistors, not shown, allowing the selection of photodetectors 25.

Photodetectors 25 are preferably made of organic materials. Photodetectors 25 are for example organic photodiodes (OPDs) integrated on a CMOS (Complementary Metal Oxide Semiconductor) substrate or a substrate with thin film transistors (TFTs). The substrate is for example made of silicon, preferably, of single-crystal silicon. The channel, source, and drain regions of the TFT transistors are for example made of amorphous silicon (a-Si), of indium gallium zinc oxide (IGZO), or of low temperature polycrystalline silicon (LIPS).

The photodiodes 25 of image sensor 21 comprise, for example, a mixture of organic semiconductor polymers, for example poly(3-hexylthiophene) or poly(3-hexylthiophene-2,5-diyl), known as P3HT, mixed with [6,6]-phenyl-C61-butyric acid methyl ester (N-type semiconductor), known as PCBM.

The photodiodes 25 of image sensor 21 for example comprise small molecules, that is, molecules having molar masses smaller than 500 g/mol, preferably, smaller than 200 g/mol.

Photodiodes 25 may be non-organic photodiodes, for example, formed based on amorphous silicon or on crystalline silicon. As an example, photodiodes 25 comprise quantum dots.

According to an embodiment, each photodetector 25 is adapted to detecting visible radiation and/or infrared radiation.

Angular filter 23 comprises:
an array 27 of micrometer-range microlenses 29, for example, plano-convex;
an array 31 or layer of holes or openings 33 delimited by walls 35 opaque (for example, absorbing or reflective) in the visible and/or infrared ranges; and
a layer 41 comprising mediums having different refraction indexes, layer 41 only letting through rays of said radiation having incidences smaller than a first maximum incidence.

According to an embodiment, the array 27 of microlenses 29 is formed on top of and in contact with a substrate or support 30, substrate 30 then being interposed between microlenses 29 and array 31.

Substrate 30 may be made of a transparent polymer which does not absorb, at least, the considered wavelengths, here in the visible and/or infrared range. This polymer may in particular be poly(ethylene terephthalate) (PET), poly(methyl methacrylate) (PMMA), cyclic olefin polymer (COP), polyimide (PI), polycarbonate (PC). The thickness of substrate 30 may vary between 1 μm and 100 μm, preferably between 10 μm and 100 μm. Substrate 30 may correspond to a colored filter, to a polarizer, to a half-wave plate or to a quarter-wave plate.

Lenses 29 may be made of silica, of PMMA, of positive resist, of PET, of poly(ethylene naphthalate) (PEN), of COP, of polydimethylsiloxane (PDMS)/silicone, of epoxy resin, or of acrylate resin. Microlenses 29 may be formed by creeping of resist blocks. Microlenses 29 may further be formed by molding on a layer of PET, of PEN, of COP, of PDMS/silicone, of epoxy resin, or of acrylate resin. Microlenses 29 are converging lenses, each having a focal distance f in the range from 1 μm to 100 μm, preferably from 1 μm to 70 μm. According to an embodiment, all the microlenses 29 are substantially identical.

According to the present embodiment, microlenses 29 and substrate 30 are preferably made of materials which are transparent or partially transparent, that is, transparent in a portion of the spectrum considered for the targeted field, for example, imaging, over the wavelength range corresponding to the wavelengths used during the exposure of an object to be imaged.

The planar surfaces of microlenses 29 face openings 33.

Call “h” the thickness of walls 35. Walls 35 are, for example, opaque to the radiation detected by photodetectors 25, for example absorbing and/or reflective with respect to the radiation detected by photodetectors 25. As an example, walls 35 absorb and/or reflect in the visible range and/or near infrared and/or infrared. Walls 35 are, for example, opaque to wavelengths in the range from 400 nm to 600 nm, used for imaging (for example, biometry and fingerprint imaging).

In the present description, there is called upper surface of layer 31 the surface of layer 31 located at the interface between layer 31 and substrate 30. There is further called lower surface of layer 31 the surface of layer 31 located opposite to the upper surface.

In FIG. 2, openings 33 are shown with a trapezoidal cross-section in the YZ plane. Generally, each opening 33 may have a square, rectangular shape, or be funnel-shaped. Each opening 33, in top view (that is, in the XZ plane), may have a circular, oval, or polygonal shape, for example, triangular, square, rectangular, or trapezoidal. Each opening 33, in top view, has a preferably circular shape. There is defined by width of an opening 33 the characteristic dimension of opening 33 in the XZ plane. For example, for an opening 33 having a square-shaped cross-section in the XZ plane, the width corresponds to the dimension of a side and for an opening 33 having a cross-section of circular shape in the XZ plane, the width corresponds to the diameter of opening 33. In the shown example, the width of openings 33, at the level of the upper surface of layer 31, is greater than the width of openings 33, at the level of the lower surface of layer 31. Further, there is called center of an opening 33 the point located at the intersection of the axis of symmetry of openings 33 and of the lower surface of layer 31. For example, for circular openings 33, the center of each opening 33 is located on the axis of revolution of opening 33.

According to an embodiment, openings 33 are arranged in rows and in columns. Openings 33 may have all substantially the same dimensions. Call “w1” the width of openings 33 at the interface with the substrate or microlenses 29 and “w2” the width of openings 33 at the interface with layer 37. Call “p” the repetition pitch of openings 33, that is, the distance, along the X axis or the Z axis, between the centers of two successive openings 33 of a row or of a column.

Each opening 33 is preferably associated with a single microlens 29. The optical axes of microlenses 29 are preferably aligned with the centers of the openings 33 of array 31. The diameter of microlenses 29 is preferably greater than the maximum width (measured perpendicularly to the optical axes) of openings 33.

Pitch p may be in the range from 5 μm to 100 μm, for example, equal to approximately 15 μm. Height h may be in the range from 1 μm to 1 mm, preferably be in the range from 12 μm to 20 μm. Width w1 may, preferably, be in the range from 5 μm to 100 μm, for example be equal to approximately 10 μm. Width w2 may preferably be in the range from 1 μm to 100 μm, for example be equal to approximately 2 μm.

According to the embodiment illustrated in FIG. 2, each photodetector 25 is associated with four openings 33 (each photodetector 25 is for example associated with two openings 33 along the X axis and with two openings 33 along the Z axis). In practice, the resolution of angular filter 23 may be more than four times greater than the resolution of image sensor 21. In other words, in practice, there may be more than four times more openings 33 than photodetectors 25, for example, eight times more.

The structure associating the array 27 of microlenses 29 and array 31 is adapted to filtering the incident radiation according to the incidence of the radiation relative to the optical axes of the microlenses 29 or array 27 which, in FIG. 2, are parallel to the Y axis. The structure associating the array 27 of microlenses 29 and array 31 is adapted to blocking at least most of, preferably all, the rays of the incident radiation having respective incidences relative to the optical axes of the microlenses 29 of filter 23 greater than a second maximum incidence, smaller than the first maximum incidence. This structure is adapted to only letting through rays having an incidence relative to the optical axes of microlenses 29 smaller than the first maximum incidence. For example, the structure only lets through incident rays having an incidence smaller than 45°, preferably smaller than 30°, more preferably smaller than 10°, more preferably still smaller than 4°, for example, in the order of 3.5°.

Openings 33 are for example filled with air, with partial vacuum, or with a material at least partially transparent in the visible and infrared ranges. The filling material of openings 33 forms, preferably, a layer 37 at the lower surface of array 31 to cover walls 35 and planarize said lower surface of array 31.

Microlenses 29 are preferably covered with a planarization layer 39. Layer 39 is made of a material at least partially transparent in the visible and infrared ranges. As an example, layer 39 has a refraction index smaller than the refraction index of the material forming microlenses 29.

According to the embodiment illustrated in FIG. 2, layer 41 is located above the array 27 of microlenses 29. More precisely, layer 41 is located on the upper surface of layer 39.

Layer 41 is adapted to filtering the incident radiation according to the incidence of the radiation relative to the Y axis. Layer 41 is adapted to only letting through rays having an incidence smaller than the first maximum incidence. In other words, layer 41 is adapted to only letting through rays, arriving onto the upper surface of layer 41, having an incidence smaller than the first maximum incidence. The first maximum incidence is preferably greater than 15°. The first maximum incidence is preferably smaller than 60°, preferably smaller than or equal to 30°.

The structure comprises the array 27 of microlenses 29 and the array 31 of openings 33 theoretically enables to block all the rays having an incidence greater than the second maximum incidence. However, in practice, it can be observed that certain rays having incidences greater than the first maximum incidence however succeed in crossing first array 31. These are rays having incidences greater than the first maximum incidence which reach a microlens 29 and pass through the underlying opening 33 of a neighboring microlens 29. This phenomenon is called optical crosstalk or parasitic coupling and may cause a decrease in the resolution of photodetectors 25 or in the contrast of the obtained image. Layer 41 aims at blocking rays having incidences greater than the second maximum incidence and which might cause optical crosstalk.

According to the embodiment illustrated in FIG. 2, layer 41 is formed of a stack of a plurality of successive sub-layers, four successive sub-layers 411, 413, 415, 417 being shown as an example in FIG. 2. Sub-layer 417 is preferably located on layer 39 and in contact with layer 39. Sub-layer 417 covers, preferably, the entire layer 39. Sub-layer 415 covers the upper surface of sub-layer 417. Sub-layer 415 is covered with sub-layer 413, which is itself covered with layer 411. Sub-layers 411, 413, 415, and 417 have, for example, the same thicknesses. Sub-layers 411, 413, 415, and 417 preferably have different thicknesses. In FIG. 2, layer 41 comprises a stack of four sub-layers. However, in practice, layer 41 may be formed of a stack of a number of sub-layers different from four. As an example, the number of sub-layers may be two.

According to the embodiment illustrated in FIG. 2, the refraction indexes of two successive sub-layers are preferably different, for example, by at least 0.15, preferably by at least 0.2. Preferably, in the case of two successive sub-layers, the lower sub-layer (that is, the sub-layer closest to sensor 21) has a refraction index smaller than the refraction index of the upper sub-layer (that is, the sub-layer more distant from sensor 21).

As an example, the refraction index of sub-layer 411 is greater by 0.15, preferably 0.2, than the refraction index of sub-layer 413. Still as an example, the refraction index of sub-layer 413 is greater by 0.15, preferably 0.2, than the refraction index of sub-layer 415. Still as an example, the refraction index of sub-layer 415 is greater by 0.15, preferably 0.2, than the refraction index of sub-layer 417.

According to a variant, not shown, the previously-described function of filtering by layer 41 with a multilayer structure may be obtained by the association of a single layer covering layer 39. This single layer then has a refraction index greater by at least 0.15, preferably by at least 0.2, than the refraction index of layer 39.

Sub-layers 411, 413, 415, and 417 are preferably made of different materials. Sub-layers 411, 413, 415, and 417 may for example be made of same chemical compounds in different proportions, have refractions indexes decreasing from layer 411 to layer 417 to deviate the rays.

As an example, layer 41 is formed of a plurality of sub-layers alternatively formed based on silicon nitride (Si₃N₄) and on air or on a polymer such as polyethylene terephthalate (PET). Layer 41 for example has a thickness in the range from 10 nm to 10 μm, preferably from 50 nm to 1 μm.

Layer 41 is preferably transparent to the wavelengths of the considered application.

According to the embodiment illustrated in FIG. 2, the filtering results from the fact that layer 41 reflects rays having an incidence greater than the first maximum incidence. More precisely, at each change of layer, the propagation medium of light rays changes. The rays then are, in contact with the diopter formed by the interface between the two successive layers, partly refracted and partly reflected. At the output of layer 41, there are almost no more rays having an incidence greater than the first maximum incidence. In other words, layer 41 is optimized to guarantee a maximum transmittance for rays having an incidence greater than the first maximum incidence.

In FIG. 2, the rays arrive onto the upper surface of layer 41 and onto microlenses 29 with different incidences. The radiation incident to device 19 comprises:
rays 43 having a null incidence relative to layer 41 (that is, perpendicular to the upper surface of layer 41);
rays 45 having an incidence α relative to layer 41, greater than 0° and smaller than or equal to the first maximum incidence, for example, approximately 30°, rays 45 having, after the crossing of layer 41, an incidence α₂₁, smaller than the second maximum incidence, for example, approximately 4°;
rays 47 having an incidence β relative to layer 41, greater than a and smaller than or equal to the first maximum incidence, for example, approximately 30°, rays 47 having, after the crossing of layer 41, an incidence β₂₂, greater than or equal to the second maximum incidence, for example, approximately 4°; and rays 49 having an incidence γ relative to layer 41, greater than the first maximum incidence.

Rays 45 and 47 are shown in layer 41 by dotted lines which only show the direction resulting from these rays as they come out of layer 41. In reality, rays 45 and 47 are refracted at each change of sub-layers of layer 41, as shown for rays 49.

According to the embodiment illustrated in FIG. 2, each ray 43 crosses layer 41 and the array 27 of microlenses 29 by emerging from one of microlenses 29 with an angle 822 to pass through the image focal point of said microlens 29. According to an embodiment, the image focal point of each microlens 29 is located on the lower surface of the array 31 of openings 33, at the center of the opening 33 having microlens 29 associated therewith. Neither layer 41, nor the structure associating the array 27 of microlenses 29 and array 31, blocks rays 43. Each ray 43 is thus captured by image sensor 21 and more precisely by the underlying photodetector 25 of the microlens 29 crossed by ray 43.

According to the embodiment illustrated in FIG. 2, each ray 45 crosses layer 41 to come out of it with an angle α₂₁. Layer 41 does not block rays 45 having an incidence smaller than the first maximum incidence. The structure associating the array 27 of microlenses 29 and array 31 does not block rays 45 since they arrive onto microlenses 29 with an incidence smaller than the second maximum incidence. Each ray 45 is thus captured by image sensor 21 and more precisely by the underlying photodetector 25 of the microlens 29 crossed by ray 45.

According to the embodiment illustrated in FIG. 2, each ray 47 crosses layer 41 to come out of it with an angle β₂₂. Layer 41 does not block rays 47 having an incidence smaller than the first maximum incidence. The structure associating the array 27 of microlenses 29 and array 31 blocks rays 47 since they arrive onto microlens 29 with an incidence greater than or equal to the second maximum incidence. Rays 47 are thus not captured by image sensor 21.

According to the embodiment illustrated in FIG. 2, all rays 49 having incidences greater than the first maximum incidence are reflected by the cumulation of the sub-layers of layer 41. In the example shown in FIG. 2, rays 49 reach the upper surface of layer 41, more precisely the upper surface of sub-layer 411, with an incidence greater than the first maximum incidence. In contact with the upper surface of sub-layer 411, a portion 49′ of rays 49 is reflected and the other portion 491 of rays 49 engages into sub-layer 411 with an angle γ₂₁₁. Rays 491 arrive onto the upper surface of sub-layer 413. In contact therewith, a portion 491′ of rays 491 is reflected and the other portion 493 of rays 491 engages into sub-layer 413 with an angle γ₂₁₃, preferably greater than angle γ₂₁₁. This phenomenon is repeated as many times as layer 41 has sub-layers. In FIG. 2, rays 493 are divided into a reflected portion 493′ and a refracted portion 495 (rays 495 having an angle γ₂₁₅ with rays 213). Rays 495 are divided into a reflected portion 495′ and a refracted portion 497 (rays 497 having an angle γ₂₁₇ with rays 215). Eventually, rays 497, in contact with layer 39, are as a large majority reflected (rays 497′). In practice, rays 497 are not all reflected and residues of rays 497 propagate, at the output of layer 41, in layer 39. They are deviated by layer 39 and blocked by the association of microlenses 29 and of array 31 since they arrive at the surface of microlenses 29 with an incidence much greater than the first incidence. Rays 49 thus do not reach photodetectors 25.

At the output of angular filter 23, image sensor 21 then only captures rays 43 and 45.

In the embodiment of FIG. 2, no opaque layer extends above layer 41. This enables to maximize the useful surface area of light collection by the angular filter. Further, in this example, layer 41 only comprises transparent materials which, here again, enables to maximize the useful surface area of light collection by the angular filter.

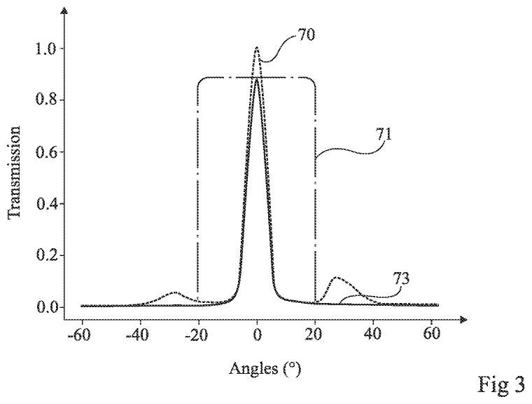

FIG. 3 shows, in a graph, the transmittance of the angular filter 23 of the device illustrated in FIG. 2 according to the incidence of the rays reaching angular filter 23.

More particularly, FIG. 3 illustrates three curves 70, 71, and 73, each representing the normalized transmittance (Transmission) of the rays in different portions of the angular filter 23 according to the incidence of said rays (Angles))(°.

The graph illustrated in FIG. 3 comprises:
a curve 70 corresponding to the transmittance of the rays crossing the structure associating the array 27 of microlenses 29 and array 31;
a curve 71 corresponding to the transmittance of the rays crossing layer 41; and
a curve 73 corresponding to the transmittance of the rays thoroughly crossing the angular filter 23 such as illustrated in FIG. 2.

In practice, the association of the array of microlenses 29 and of array 31, respectively, array 41, does not enable to fully block rays having an incidence greater than the second maximum incidence, respectively the first maximum incidence. It is then spoken of a blocking value, that is, the second maximum incidence value, respectively the first maximum incidence value, as being the half width at half maximum of the transmittance, or the half width at half maximum of curve 70, respectively curve 71. In other words, rays having an incidence equal to this value are blocked at 50%, rays having an incidence greater than this value are mostly non-blocked, and rays having an incidence smaller than this value are mostly blocked by the association of the array of microlenses and of first array 31, respectively by second array 41.

With the previously-indicated dimensions, the half width at half maximum of curve 70 or the half width at half maximum of the transmittance of the assembly formed by the array 27 of microlenses 29 and array 31 (HWHM: Half Width Half Maximum) is equal to approximately 3.5° and the half width at half maximum of curve 71 or half width at half maximum of the transmittance of layer 41 is equal to approximately 20°.

First curve 70 comprises two second peaks, called secondary peaks, for incidences of approximately 25° and −25°. The transmittance, of rays having an incidence equal to approximately 25°, is approximately equal to 0.05. These secondary peaks correspond to the passage, through the array of microlenses 29 and array 31, of rays having incidences in the range from approximately 20° to approximately 40°, captured by a photodetector 25 next to the photodetector 25 underlying the microlens 29 or the opening 33 crossed by the ray.

Second curve 71 is characteristic of a bandpass filter letting through rays having incidences between −20° and 20°.

Mathematically, the values of curve 73 correspond to a multiplication of the value of curve 70 and of the value of curve 71 for a same given incidence. Third curve 73 has, as compared with curve 70, no secondary peaks. The transmittance of the rays beyond 20° then tends towards 0.

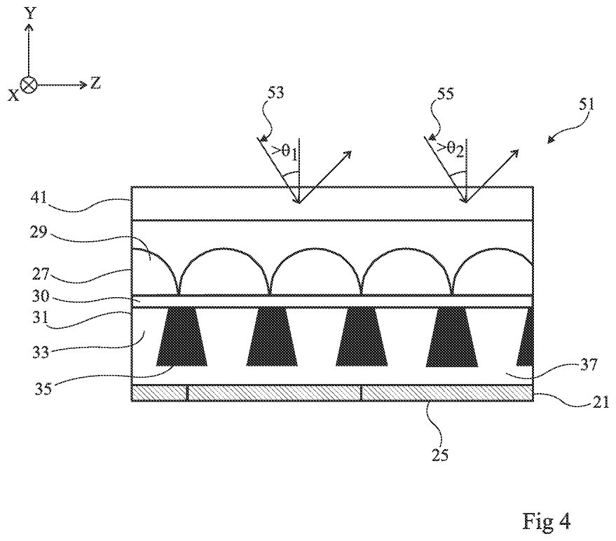

FIG. 4 illustrates, in a partial and simplified cross-section view, another embodiment of an image acquisition device 51.

More particularly, FIG. 4 illustrates an image acquisition device 51 similar to the device 19 illustrated in FIG. 2, with the difference that layer 41 is an interference bandpass filter, that is, a filter only letting through a radiation having wavelengths in a given wavelength range.

The inventors have indeed observed that an interference filter also behaves as an angular filter due to its angular tolerance. In other words, the cut-off wavelength range depends on the incidence. Indeed, an interference filter blocks, for each incidence, a different wavelength range.

For example, a ray 53 having a wavelength λ₁ is blocked (reflected and/or absorbed) if its incidence is greater than an angle θ₁ while a ray 55 having a wavelength λ₂ is blocked (reflected and/or absorbed) if its incidence is greater than an angle θ₂ different from angle θ₁.

According to an embodiment, layer 41 is formed by the stacking of a plurality of layers having different refraction indexes. As an example, layer 41 comprises an alternation of first layers of a first material having a first refraction index and of second layers of a second material having a second refraction index different from the first refraction index. As an example, layer 41 comprises an alternation of layers made of magnesium fluoride and of layers made of alumina or an alternation of layers made of tantalum pentoxide and of layers made of silicon dioxide. As a variant, layer 41 comprises an alternation of layers made of one or a plurality of materials from the list: magnesium fluorine, tantalum pentoxide, silicon dioxide, trititanium pentoxide, hafnium dioxide. Layer 41 may further comprise an alternation of layers made of gold, of silver, of chromium, of nickel, or of aluminum, or of one or a plurality of their derivatives.

As a variant, the layer 41 illustrated in FIG. 4 may be located between the array of microlenses 29 and array 31 or between array 31 and image sensor 21.

In the embodiment of FIG. 4, no opaque layer extends above layer 41. This enables to maximize the useful surface area of light collection by the angular filter. Further, in this example, layer 41 only comprises transparent layers (made of transparent materials or sufficiently thin to be transparent) which, here again, enables to maximize the useful surface area of light collection by the angular filter.

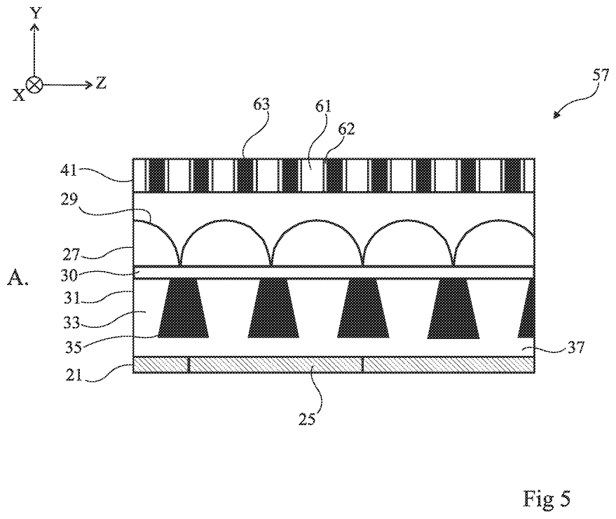

FIG. 5 illustrates another embodiment of an image acquisition device 57.

More particularly, FIG. 5 illustrates an image acquisition device 57 similar to the device 19 illustrated in FIG. 2 with the difference that layer 41 is a fiber optic plate (FOP).

Layer 41 corresponds to the gathering of a plurality of optical fibers placed next to each other and arranged substantially parallel to the Y axis.

According to the embodiment illustrated in FIG. 5, each optical fiber comprises a core 61 surrounded with a sheath 62. The core is made of a first material having a first refraction index and the sheath is made of a second material having a second refraction index, the first and second materials being transparent to the incident radiation, and the first index being greater than the second index.

As an example, as shown in FIG. 5, the spaces between the optical fibers are filled with a black resin 63, preferably absorbing for the considered radiation. In other words, layer 41 comprises a black resin 43 used to fill the holes between optical fibers.

The angular selection of the optical fibers is due to the difference in refraction index between the core 61 and the sheath 63 of the fibers. The optical fibers have a digital aperture which thus depends on the refraction indexes of core 61 and of sheath 62. The digital aperture of the fibers is calculated by the following formula:

ON=\sqrt{index of core 61²−index of sheath 63²} [Math 1]

The maximum incidence particularly depends on the characteristics of the optical fibers, on the thickness of layer 41.

As an example, each optical fiber has a substantially cylindrical shape with a circular base. The outer diameter of an optical fiber is for example in the range from 6 μm to 25 μm.

According to the embodiment illustrated in FIG. 5, layer 41 is located on the upper surface of the array 27 of microlenses 29 and is, for example, bonded thereto by means of an adhesive. However, layer 41 may as a variant be located between microlenses 29 and array 31 or between array 31 and image sensor 21.

In the embodiment of FIG. 5, no opaque layer extends above layer 41. This enables to maximize the useful surface area of light collection by the angular filter.

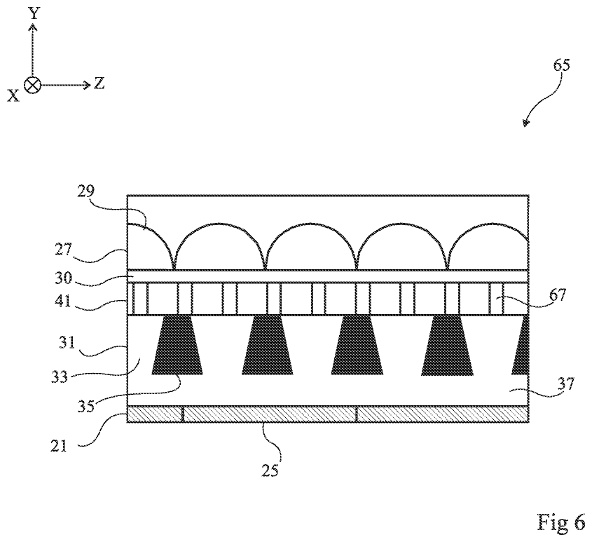

FIG. 6 illustrates another embodiment of an image acquisition device 65.

More particularly, FIG. 6 illustrates an image acquisition device 65 similar to the device 19 illustrated in FIG. 2 with the difference that layer 41 is a structured layer located between the array of microlenses 29 and array 31.

Layer 41 preferably corresponds to a structured layer such as a photonic crystal, that is, it is a layer made of a first material having a first refraction index crossed by pillars 67 extending along the Y axis and arranged in an array, pillars 67 being made of a second material having a second refraction index different from the first refraction index, the first and second materials being transparent to the incident radiation.

Pillars 67 have, in FIG. 6, substantially cylindrical shapes with a base corresponding to a circle, an ellipse, a square, a rectangle, a parallelogram, a polygon, etc. As a variant, pillars 67 substantially have the shape of cones, of truncated cones, of pyramids, or of truncated pyramids. Pillars 67 may as a variant have any shape.

The properties of the photonic crystal, particularly the dimensions of pillars 67 and the arrangement of pillars 76 in an array, are selected so that the combination of layer 41 and of the structure associating the array 27 of microlenses and the array 31 of openings 33 enables to completely block incident rays having an incidence greater than the first maximum incidence. The total blocking of incident rays having an incidence greater than the first maximum incidence enables to decrease, or even to suppress, the optical crosstalk.

In the embodiment of FIG. 6, no opaque layer extends above layer 41. This enables to maximize the useful surface area of light collection by the angular filter. Further, in this example, layer 41 only comprises transparent materials which, here again, enables to maximize the useful surface area of light collection by the angular filter.

Various embodiments and variants have been described. Those skilled in the art will understand that certain features of these various embodiments and variants may be combined, and other variants will occur to those skilled in the art. The described embodiments are for example not limited to the examples of dimensions and of materials mentioned hereabove.

Finally, the practical implementation of the described embodiments and variations is within the abilities of those skilled in the art based on the functional indications given hereabove.

1. An angular filter for an image acquisition device comprising a stack, the angular filter comprising:
a layer comprising mediums having different refraction indexes and transparent to said radiation, the layer only letting through rays of said radiation having incidences smaller than a first maximum incidence; and
an array of openings delimited by walls opaque to a visible and/or infrared radiation and an array of microlenses,
wherein an assembly formed by the array of openings and the array of microlenses only letting through rays of said radiation having incidences smaller than a second maximum incidence smaller than the first maximum incidence,
and wherein no opaque layer extends above said layer.

2. The angular filter according to claim 1, wherein said layer comprises a plurality of sub-layers.

3. The angular filter according to claim 2, wherein the refraction index of each sub-layer is different from the refraction index of the sub-layer that it covers by at least 0.15 or 0.2.

4. The angular filter according to claim 1, wherein the layer is an interference filter.

5. The angular filter according to claim 1, wherein the layer is a fiber optic panel.

6. The angular filter according to claim 5, wherein the layer comprises a group of optical fibers.

7. The angular filter according to claim 5, wherein the layer comprises a group of parallel optical fibers, each surrounded with an opaque material.

8. The angular filter according to claim 1, wherein the layer corresponds to a microstructured layer that can be assimilated to a photonic crystal, the microstructured layer having a resolution greater than the resolution of the array of microlenses.

9. The angular filter according to claim 8, wherein the layer comprises a film of a first material transparent to said radiation crossed by pillars of a second material transparent to said radiation arranged in an array.

10. The angular filter according to claim 1, wherein the array of microlenses is located between the array and the layer.

11. The angular filter according to claim 1, wherein the layer is located between the array of microlenses and the array.

12. The angular filter according to claim 1, wherein the array is located between the array of microlenses and the layer.

13. The angular filter according to claim 1, wherein the second maximum incidence, which corresponds to the half width at half maximum of the transmittance, is smaller than 10°, preferably smaller than 4°.

14. The angular filter according to claim 1, wherein the first maximum incidence, which corresponds to the half width at half maximum of the transmittance, is greater than 15° and smaller than 60°.

15. The angular filter according to claim 1, wherein the first maximum incidence is smaller than or equal to 30°.

16. The angular filter according to claim 1, wherein the openings are filled with air, with a partial vacuum, or with a material at least partially transparent in the visible and infrared ranges.

17. The angular filter according to claim 1, wherein:
each opening is topped with a single microlens
each microlens covers a single opening; and/or
the optical axis of each microlens is aligned with the center of an opening.

18. An image acquisition device comprising an angular filter according to claim 1, and an image sensor.
